(19) United States
(12) Patent Application Publication
(10) Pub. No.: US 2009/0304097 A1
(43) Pub. Date: Dec. 10, 2009

(54) TRANSMITTING APPARATUS AND METHOD USING TONE RESERVATION IN OFDM SYSTEM

(76) Inventors: Seung Hee Han, Seoul (KR); Min Seok Noh, Seoul (KR); Yeong Hyeon Kwon, Gyeonggi-do (KR); Young Woo Yun, Seoul (KR); Ki Jun Kim, Seoul (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/161,947

(22) PCT Filed: Jan. 24, 2007
(86) PCT No.: PCT/KR2007/000429

§ 371 Date: May 19, 2009

(30) Foreign Application Priority Data
Jan. 24, 2006 (KR) 10-2006-0007290

(51) Int. Cl. H04J 11/00; H04L 27/28

(52) U.S. Cl. 375/260

(57) ABSTRACT

The present invention relates to an apparatus and a method for transmitting orthogonal frequency division multiplexing (OFDM) signals using a tone reservation scheme. Preferably, the present invention comprises an inserter to add a transmit format indicator (TFI) to an encoded packet, the TFI including a tone reservation rate for a peak to average power ratio (PAPR) control; a reordering module to change order of bits included in the encoded packet by discriminating information bits and parity bits of the encoded packet; a zero replacement module to replace a portion of the parity bits with at least one bit set for a PAPR control;’ a transmitter to transmit the replaced output using a plurality of orthogonal sub-carriers; and a controller to control the tone reservation rate based on status of received signals.

### TECHNICAL FIELD

The present invention relates to an apparatus and a method for transmitting orthogonal frequency division multiplexing signals, and more particularly, to an apparatus and a method for transmitting orthogonal frequency division multiplexing (hereinafter, referred to ‘OFDM’) signals using a tone reservation scheme.

### BACKGROUND ART

According to the CFDM method, a data transmission is performed by a plurality of sub-carriers in a specific bandwidth. The OFDM method enables to perform a fast data transmission. A communication system adopting the OFDM method (hereinafter, referred to ‘OFDM system’) may encode signals based on an inverse fast fourier transform (IFFT) operation and decode the signals based on a fast fourier transform (FFT) operation.

The OFDM system shows a high bandwidth-efficiency, because a plurality of sub-carriers are overlapped in a manner of maintaining an orthogonality.

Moreover, the OFDM system has a strong property for multipath fading having a frequency selectivity, since the OFDM system performs a low speed transmission using a plurality of sub-carriers.

Because of the above mentioned advantage, the OFDM method is adopted in IEEE 802.11a, IEEE 802.16, DVB (Digital Video Broadcasting) standard.

However, the OFDM method has a problem when a Peak-to-Average-Power Ratio (hereinafter, referred to ‘PAPR’) of a signal to be transmitted is high. According to the OFDM method, frequency domain signals are inverse fast fourier transformed first, and the transformed signals are transmitted by a plurality of sub-carriers. Therefore, an amplitude of the OFDM signal is determined by sum of the plurality of the sub-carriers. When the plurality of sub-carriers have the same phase, the OFDM signal has a very high PAPR value. In general, since a power amplifier having a large linear span is expensive, the ODFM signal having a high PAPR value is distorted.

### DISCLOSURE OF THE INVENTION

Therefore, the present invention has been made in view of the above problem, and it is an aspect of the present invention to provide an apparatus and a method of reducing a PAPR efficiently in the OFDM system.

In accordance with an aspect of the present invention, the above and other objects can be accomplished by an apparatus for transmitting orthogonal frequency division multiplexing (OFDM) signals using a tone reservation scheme, the apparatus comprising: an inserter to add a transmit format indicator (TFI) to an encoded packet, the transmit format indicator (TFI) including a tone reservation rate for controlling a peak to average power ratio (PAPR); a reordering module to change order of bits included in the encoded packet by discriminating information bits and parity bits of the encoded packet; a zero replacement module to replace a portion of the parity bits with at least one bit set for controlling the peak to average power ratio (PAPR); a transmitter to transmit the replaced output using a plurality of orthogonal sub-carriers; and a controller to control the tone reservation rate based on status of received signals.

In a further aspect of the present invention, there is provided a method for transmitting orthogonal frequency division multiplexing (OFDM) signals using a tone reservation scheme, the method comprising, acquiring information regarding reception status of received signals, and transmitting the orthogonal frequency division multiplexing (OFDM) signals by sub-carriers corresponding to a total bandwidth, wherein the sub-carriers include at least one sub-carrier allocated by a transmitter for controlling a peak to average power ratio (PAPR), and wherein the at least one sub-carrier is allocated based on a tone reservation rate corresponding to the reception status.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram to explain an OFDM transmitter controlling a PAPR based on a tone reservation (TR) scheme;

FIG. 2 is a block diagram to explain a module performing a gradient algorithm;

FIG. 3 is a block diagram to explain an OFDM transmitter using an adaptive TRR scheme;

FIG. 4 is a block diagram to explain packets of which a TFI inserting and reordering module outputs;

FIG. 5 is a block diagram to explain packets of which a zero replacement module outputs; and

FIG. 6 is a block diagram to explain an OFDM receiver using an adaptive tone reservation (TR) scheme.

### BEST MODE FOR CARRYING OUT THE INVENTION

Reference will now be made in detail to embodiments of the present invention, examples of which are illustrated in the accompanying drawings.

A communication system using an OFDM method may adopt a clipping scheme or block coding scheme to reduce a PAPR. In addition, a scrambling scheme, which controls phases of signals, and a tone reservation (hereinafter, referred to ‘TR’) scheme can be adopted as a way of reducing a PAPR.

The clipping scheme can create a self-interference problem in a certain frequency band by distorting OFDM signals, where the self-interference can deteriorate a bit error rate (Hereinafter, referred to ‘BER’) property. Moreover, operations performed by the clipping scheme belong to a non-linear operation, which can create unexpected frequency elements outside of desired frequency band.

The block coding scheme encodes a PAPR reducing code in remaining sub-carriers so that a PAPR of all sub-carriers is reduced. According to the block coding scheme, a maximum power can be maintained below a certain level and a PAPR reduction can be achieved without distortion of OFDM signals. However, data transmission efficiency decreases because of low code rate of the block coding and size of a lookup table or generation matrix needed for the block coding scheme is increasing when the number of sub-carriers is great. This can increase complexity and the number of calculations.

The scrambling scheme can be categorized into a selected mapping method (hereinafter, referred to ‘SLM’) and a partial transmit sequence (hereinafter, referred to ‘PTS’) scheme.

The SLM is a method to multiply U number of different phase vectors by single information, perform an IFFT operation to the each of multiplied outputs and then select and transmit the IFFT performed output having a lowest PAPR among the U number of IFFT performed outputs. According to the SLM, a PAPR can be significantly reduced though U number of IFFT operations is required. However, as the number of the phase vectors increases, the number of IFFT operations and PAPR calculation process also increase. Moreover, amount of additional information indicating the phase vectors can be increased.

The PTS scheme is a method to divide input data into M number of sub-blocks, perform an IFFT operation, multiply outputs from the M sub-blocks by phase elements reducing PAPRs of the outputs and sum up the multiplied outputs. A PAPR reducing performance of the PTS scheme is better than that of the SLM. However, the PTS scheme has a problem of calculation complexity. Since a great number of IFFT operations need to be performed in the M number of sub-blocks, the calculation complexity of the PTS scheme increases. Moreover, when the number of sub-blocks is large, there exists a problem that amount of information regarding the phase elements is huge.

The TR scheme selects a portion of sub-carriers to reduce a PAPR. In other words, the selected sub-carriers are dedicated to controlling the PAPR and remaining sub-carriers are utilized for data transmission. Since a receiver supporting the TR scheme receives data via sub-carriers except the selected sub-carrier, the receiver can be implemented easily.

One representative example of the TR scheme is a gradient algorithm. The gradient algorithm is a method of which the clipping scheme is applied to the TR scheme. According to the gradient algorithm, a transmitter creates signals having a property of an impulse signal using at least one tone (i.e. at least one sub-carrier) which does not transmit data and clips output signals from IFFT blocks using the signals which has a property of an impulse signal. If the output signals from IFFT blocks are added to the signals which have a property of an impulse signal, signal distortion only exists in tones which do not transmit data. Eventually, signal distortion does not exist in a frequency band for data transmission.

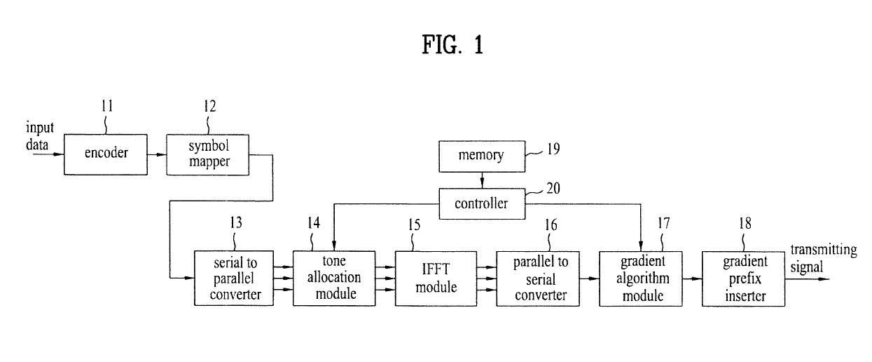

FIG. 1 is a block diagram to explain an OFDM transmitter controlling a PAPR based on a TR scheme. As shown in FIG. 1, an OFDM transmitter includes an encoder 11, a symbol mapper 12, a serial to parallel converter 13, a tone allocation module 14, an IFFT module 15, a parallel to serial converter 16, a gradient algorithm module 17, a cyclic prefix inserter 18, memory 19 and a controller 20.

Referring to FIG. 1, operations performed by the OFDM transmitter to control a PAPR according to the TR scheme are explained as follows.

The encoder 11 performs encoding of input data bits. Preferably, the encoder 11 performs a convolutional coding or a turbo coding. Meanwhile, the symbol mapper 12 generates constellation symbols by modulating the encoded bits. The serial to parallel converter 13 converts the constellation symbols inputted serially to parallel signals. The tone allocation module 14 allocates the parallel signals to N-L number of sub-carriers among total N number of sub-carriers. The N is indicative of the number of sub-carriers corresponding to total bandwidth of OFDM system, and the L is indicative of the number of sub-carriers used for reducing a PAPR. Preferably, the L number of sub-carriers is only used for reducing a PAPR, and remaining sub-carriers are used for data transmission. Mapping information regarding relationship between the parallel signals and N-L number of sub-carriers is stored in the memory 19. The mapping information further includes information regarding the L number of sub-carriers. The controller 20 provides the mapping information to the tone allocation module 14 and enables the N-L number of sub-carriers to be allocated to those parallel signals.

Tone signals corresponding to the L number of sub-carriers used for reducing a PAPR is described as follows.

$${C}_{k} = \{ \begin{matrix}{C}_{k} , & k ∈ \{ {i}_{1} , {i}_{2} , … , {i}_{L} \} \\ 0 , & k ∉ \{ {i}_{1} , {i}_{2} , … , {i}_{L} \}\end{matrix} \qquad [ Equation 1 ]$$

As shown in the equation 1, tone signals corresponding to the L number of sub-carriers can be reserved in advance. Preferably, location of the L number of sub-carriers is negotiated when the initial communication is established. Preferably, the location of the L number of sub-carriers is fixed while the normal communication is ongoing.

Meanwhile, tone signals corresponding to the N-L number of sub-carriers used for data transmission is described as follows.

$${X}_{k} = \{ \begin{matrix}0 , & k ∈ \{ {i}_{1} , {i}_{2} , … , {i}_{L} \} \\ {X}_{k} , & k ∉ \{ {i}_{1} , {i}_{2} , … , {i}_{L} \}\end{matrix} \qquad [ Equation 2 ]$$

The IFFT module 15 performs N point IFFT, and the output of the IFFT module 15 is inputted to the parallel to serial converter 16. Output signals (hereinafter, referred to ‘x’) converted to serial signals by the parallel to serial converter 16 are inputted to the gradient algorithm module 17.

The gradient algorithm module 17 generates a waveform (hereinafter, referred to ‘P waveform’) having a property of an impulse signal to control a PAPR according to the controller and performs a gradient algorithm using the P waveform. The controller 20 enables the gradient algorithm module 17 to perform a gradient algorithm based on the mapping information stored in the memory 19.

The gradient algorithm module 17 generates code c in time domain. The code c and the signals x from the gradient algorithm module 17 are added, and the added signals are inputted to the cyclic prefix inserter 18. The cyclic prefix inserter 18 inserts conventional cyclic prefix (CP) and configures OFDM signals to be transmitted.

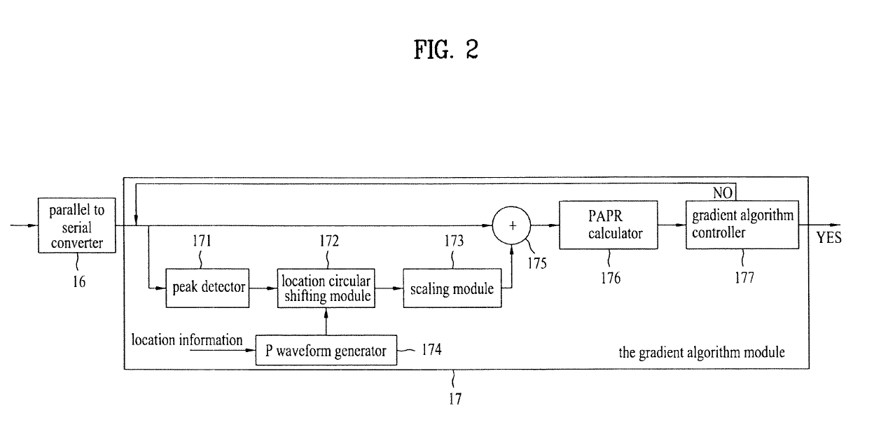

FIG. 2 is a block diagram to explain a module performing a gradient algorithm. As shown in FIG. 2, the gradient algorithm module 17 includes a peak detector 171, a location circular shifting module 172, a scaling module 173, a P waveform generator 174, an adder 175, a PAPR calculator 176 and a gradient algorithm controller 177.

The P waveform generator 174 generates a P waveform using the L number of sub-carrier reserved in advance. Since generating the P waveform having a property of an impulse signal is difficult, the P waveform generator 174 configures the P waveform by selecting sub-carriers which have minimum amplitude except a specific point corresponding to maximum amplitude.

The peak detector 171 detects OFDM samples greater than a predetermined threshold among the x signals inputted from the gradient algorithm module 17. The location circular shifting module 172 moves the generated P waveform to the points where the detected OFDM samples exist using a circular shift.

The scaling module 173 performs scaling the detected OFDM samples to generate the code c. The adder 175 outputs a c+x signal by adding the code c and the signals x. The PAPR calculator 176 calculates a PAPR of the c+x signal, and the calculated PAPR is inputted to the algorithm controller 177.

The algorithm controller 177 outputs the current values when the calculated PAPR is less than a predetermined threshold. If the calculated PAPR is greater than the predetermined threshold, the algorithm controller 177 enables the gradient algorithm module 17 to iterate the procedures until the calculated PAPR becomes less than the predetermined threshold. Preferably, the maximum number that the iteration can be performed is predetermined. When the number of iteration reaches the maximum number, a signal having the last calculated PAPR is transmitted.

The iteration operation is described as a following equation.

$${\overline{x}}^{i + 1} = {\overline{x}}^{i} - μ {\sum }_{\vert {\overline{x}}_{n}^{i} \vert > A} {α}_{n}^{i} {p}_{n} \qquad [ Equation 3 ]$$

The αₙⁱ is determined by an equation of αₙⁱ=xₙ⁻ⁱ−Ae^{jarg(x}^{ₙ}^{^{−i}}⁾, μ the is indicative of size of step, the n is indicative of OFDM indices and the i is indicative of iteration number.

When the TR scheme is applied as described above, since sub-carriers corresponding to the tone reservation rate (e.g. 5%, 10%, and 15% of all sub-carriers) can not be used for data transmission, a throughput of system may deteriorate.

When a mobile station is far from a base station or the channel condition is poor, transmission power for OFDM signals may increase. In general, operations of a transmitter are performed in a non-linear zone when the transmission power is high, so a problem such that the OFDM signals are distorted arises. Therefore, sub-carriers for a PAPR are preferably preserved in advance.

Meanwhile, when a mobile station is near a base station or the channel condition is good, quality of OFDM signals can be maintained because operations of the transmitter are performed in a linear zone. In this case, since no distortion of the OFDM signals occurs, a PAPR does not need to be reduced.

In conclusion, the tone reservation rate (hereinafter, referred to ‘TRR’) is controlled adaptively based on transmission power to the mobile station to control a PAPR more efficiently.

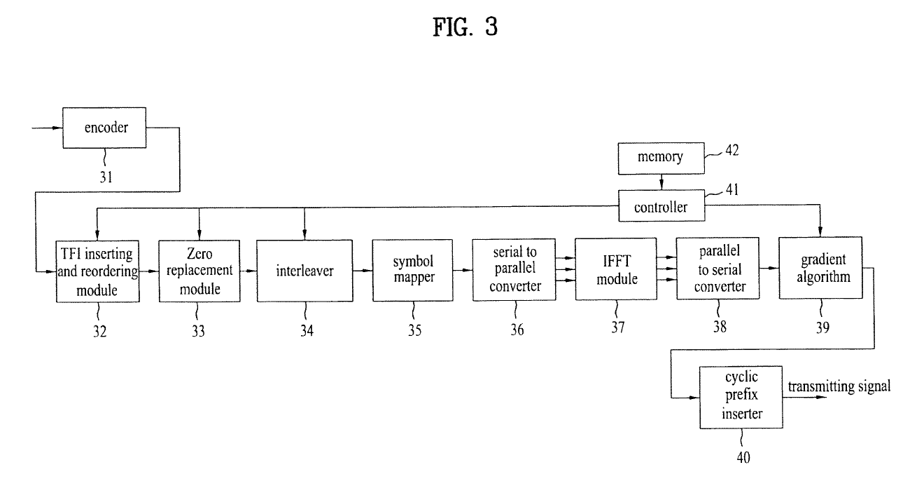

FIG. 3 is a block diagram to explain an OFDM transmitter using an adaptive TRR scheme. As shown in FIG. 3, the OFDM transmitter includes a encoder 31, a transmit format indicator (hereinafter, referred to ‘TFI’) inserting and reordering module 32 to insert a TFI and change order of encoded codeword, a zero replacement module 33, an interleaver 34, a symbol mapper 35, a serial to parallel converter 36, an IFFT module 37, a parallel to serial converter 38, a gradient algorithm 39, a cyclic prefix inserter 40, a memory 41 and a controller 42.

Hereinafter, operations of the OFDM transmitter using the adaptive TRR scheme are explained as follows.

The encoder 31 performs encoding of input data bits. Preferably, the encoder 31 performs a convolutional coding or a turbo coding. The encoded bits are inputted to the TFI inserting and reordering module 32.

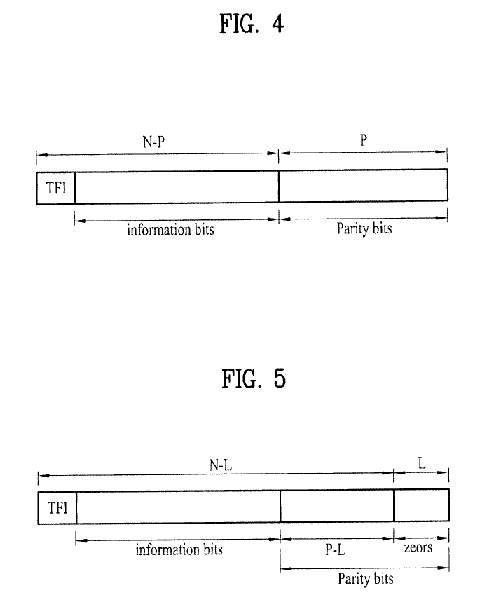

FIG. 4 is a block diagram to explain packets of which the TFI inserting and reordering module 32 outputs. The TFI inserting and reordering module 32 adds the TFI 401 including the TRR to the encoded packets according to control signals from the controller 42. The TFI is determined based on the TRR (e.g., one of 0%, 5%, 10% and 20%).

The TFI inserting and reordering module 32 changes order of bits by discriminating information bits 402 and parity bits 403 based on priority of bits outputted by the encoder 31. In FIG. 4, N is indicative of the number of all sub-carriers and P is indicative of the number of parity bits.

The zero replacement module 33 determines the number of sub-carriers reserved for PAPR control to reduce a PAPR according to TRR inputted from the controller 42.

FIG. 5 is a block diagram to explain packets of which the zero replacement module 33 outputs. As shown in FIG. 5, the zero replacement module 33 replaces a portion of the parity bits with at least one bit set for PAPR control. In FIG. 5, L is indicative of the number of bits used for PAPR control, where the L is determined by the TRR.

The interleaver 34 performs an interleaving operation except for bits corresponding to at least one tone (i.e. sub-carrier) reserved by the controller 41 in advance. The mapper 35 performs a constellation mapping to the interleaved bits based on a BPSK, QPSK, 16 QAM, 64 QAM and the like. Symbols generated by the mapper 35 are inputted to the IFFT module 37 by the serial to parallel converter 36, and the outputs of the IFFT module 37 is inputted to the gradient algorithm module 39 by the parallel to serial converter 38. Namely, the gradient algorithm module 39 generates the P waveform having a property of an impulse signal for PAPR control, using location information regarding locations of sub-carriers in frequency domain received from the memory 42 and the controller 41.

The time domain code c generated by the gradient algorithm module 39 is added to the signals x outputted from the parallel to serial converter 38. The added signals are inputted to the cyclic prefix inserter 40. The cyclic prefix inserter 40 inserts the cyclic prefix and configures OFDM signals to be transmitted.

The controller 41 acquires information regarding TRR according to the transmission power, quantizes the acquired information and controls the TFI inserting and reordering module 32 and the zero replacement module 33 by the quantized information. The controller 41 also controls the interleaver 33 to perform an interleaving operation except for the reserved tones. The location information regarding locations of sub-carriers corresponding to the TRR is stored in the memory 42. Meanwhile, the information regarding locations of sub-carriers is determined by following rules of following equation 4.

Loc_{5%}εLoc_{10%}εLoc_{20%} [Equation 4]

In the equation 4, the Loc_{20%} indicates locations of reserved sub-carriers for PAPR control when the TRR is 20%, the LOC_{10%} indicates locations of reserved sub-carriers for PAPR control when the TRR is 10% and LOC_{5%} indicates locations of reserved sub-carriers for PAPR control when the TRR is 5%.

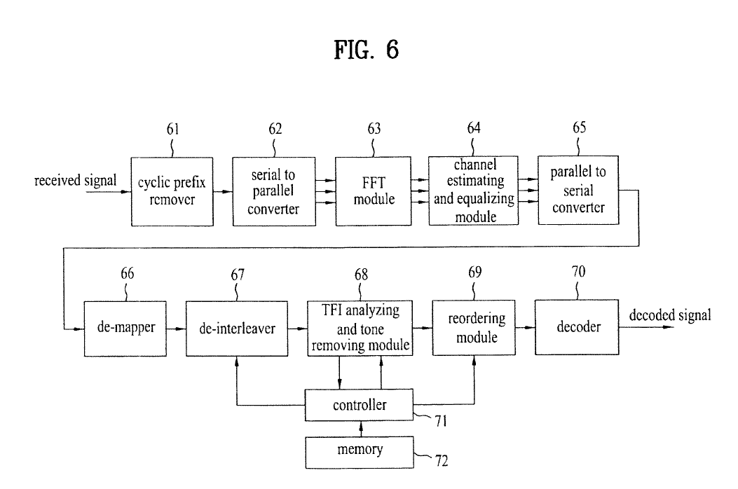

FIG. 6 is a block diagram to explain an OFDM receiver using the adaptive TRR scheme. As shown in FIG. 6, the OFDM receiver using the adaptive TRR scheme includes a cyclic prefix remover 61, serial to parallel converter 62, a FFT module 63, a channel estimating and equalizing module 64, a parallel to serial converter 65, a de-mapper 66, a de-interleaver 67, a TFI analyzing and tone removing module 68, a reordering module 69, a decoder 70, a controller 71 and a memory 72.

The OFDM receiver shown in FIG. 6 is explained as follows. The receiver receives distorted OFDM signals through a wireless channel, and removes the cyclic prefix by the cyclic prefix remover 61. The serial to parallel converter 62 converts received serial signals to parallel signals and inputs to the FFT module 63. The FFT module 63 transforms time domain signals to frequency domain signals and a channel estimating and equalizing module 64 performs a channel estimation and equalization. The parallel to serial converter 65 converts the equalized signals to serial signals, and the de-mapper 66 performs a de-constellation based on BPSK, QPSK, 16 QAM, 64 QAM and the like. Namely, the de-mapper 66 outputs bit stream corresponding to data symbols.

The bit stream is divided into TFI, information bits and parity bits by the de-interleaver 67. The controller 71 controls the TFI analyzing and tone removing module 68 to replace bits for PAPR control with zeros according to TRR stored in a memory 72 and the TFI, and then inputs replaced signals to the decoder 70 through the reordering module 69. The decoder 70 performs a decoding and restores original signals.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

### INDUSTRIAL APPLICABILITY

The present teaching can be readily applied to all types of apparatuses including a mobile terminal and base station.

What is claimed is:

1. An apparatus for transmitting orthogonal frequency division multiplexing (OFDM) signals using a tone reservation scheme, the apparatus comprising:
an inserter to add a transmit format indicator (TFI) to an encoded packet, the TFI including a tone reservation rate for controlling a peak to average power ratio (PAPR);
a reordering module to change order of bits included in the encoded packet by discriminating information bits and parity bits of the encoded packet;
a zero replacement module to replace a portion of the parity bits with at least one bit set for controlling the PAPR;
a transmitter to transmit the replaced output using a plurality of orthogonal sub-carriers; and
a controller to control the tone reservation rate based on status of received signals.

2. The apparatus of claim 1, wherein the transmitter includes a gradient algorithm module to control the PAPR using signals which have a property of an impulse signal.

3. The apparatus of claim 1, wherein the tone reservation rate has a higher value when the status of the received signals is poor.

4. The apparatus of claim 1, wherein the controller includes a memory which saves the tone reservation rate corresponding to quantized status of the received signals.

5. The apparatus of claim 4, wherein a location for tones corresponding to a higher tone reservation rate includes a location for tones corresponding to a lower tone reservation rate.

6. The apparatus of claim 4, wherein the tone reservation rate is one of 0%, 5%, 10% and 20%.

7. A method of transmitting orthogonal frequency division multiplexing (OFDM) signals using a tone reservation scheme, the method comprising,
acquiring information regarding reception status of received signals; and
transmitting the OFDM signals by sub-carriers corresponding to a total bandwidth,
wherein the sub-carriers include at least one sub-carrier allocated by a transmitter for controlling a peak to average power ratio (PAPR), and the at least one sub-carrier is allocated based on a tone reservation rate corresponding to the reception status of received signals.

8. The method of claim 7, wherein the tone reservation rate is decreased when the reception status of received signals is good.

9. The method of claim 8, wherein the transmitted OFDM signals include a transmit format indicator (TFI) corresponding to the tone reservation rate.

10. The method of claim 7, wherein the step of transmitting includes controlling the PAPR of the OFDM signals using a gradient algorithm according to the tone reservation rate.
